(19) United States
(12) Patent Application Publication
(10) Pub. No.: US 2014/0360591 A1
(43) Pub. Date: Dec. 11, 2014

(54) UNDERDRAIN FOR A FILTER SYSTEM FOR FILTERING WATER OR WASTEWATER AND A METHOD OF WASHING THE FILTER SYSTEM

(71) Applicant: ROBERTS MARKETING DE, INC., Wilmington, DE (US)

(72) Inventor: R. Lee Roberts, Rose Valley, PA (US)

(73) Assignee: ROBERTS MARKETING DE, INC., Wilmington, DE (US)

(21) Appl. No.: 13/911,255

(22) Filed: Jun. 6, 2013

(51) Int. Cl. B01D 24/24; B01D 24/46

(52) U.S. Cl. CPC B01D 24/24; B01D 24/4631
USPC 137/238; 137/544

(57) ABSTRACT

An apparatus for use in a filter system for filtering water or wastewater. The apparatus preferably includes an underdrain lateral having a plurality of chambers. Each of the plurality of chambers is preferably configured to direct a combined washing liquid and washing gas into a filter bed during a cleaning or washing cycle. The apparatus further includes one or more flow control members operably associated with the underdrain lateral for improving distribution of the combined washing liquid and washing gas through the filter bed. Each of the one or more flow control members is preferably a baffle assembly having a plate and a plurality of baffles operably associated with the plate. Preferably, one or more baffle assemblies are configured to be inserted into one or more chambers of the underdrain lateral.

### FIELD OF THE INVENTION

The present invention is directed to water and/or wastewater filter systems for filtering impurities from a liquid. More particularly, the present invention is directed to components for distributing fluids through a filter bed where the filter bed has at least one layer of filter media.

### BACKGROUND OF THE INVENTION

Various filter systems have been developed to filter water and wastewater. Typical filter systems include but are not limited to upflow filters, upflow clarifiers, downflow filters, downflow clarifiers, bi-flow filters as well as various combinations of the aforementioned filter systems. The terms upflow filter and upflow clarifier refer to filter systems in which influent to be filtered is directed in an upward path to remove impurities. Conversely, the terms downflow filter and downflow clarifier refer to filter systems in which the influent is directed in a downward path to remove impurities. Bi-flow filters refer to filter systems in which the influent is directed in both a downward path and an upward path to remove impurities. The upflow filters/clarifiers, downflow filters/clarifiers and bi-flow filters include one or more filter beds formed from one or more layers of filter media. The filter media may be supported by one or more layers of gravel. Alternatively, the one or more gravel layers may be replaced with a porous plate or other direct retention mechanism.

In a combined system, for example, an upflow filter/clarifier followed by a downflow filter, the influent is initially directed upwardly through the upflow filter/clarifier to remove a predetermined percentage of the impurities in the influent and then directed downwardly through the downflow filter to remove the remaining impurities to within an acceptable limit. Where the filter system includes multiple downflow filters connected in series, the influent is directed downwardly through each of the downflow filters one after the other to remove the impurities within an acceptable limit.

Regardless of the type of granular bed filter system and/or the type of the liquid to be filtered, it is common for the filter system to include an underdrain. The underdrain directs and receives fluids during operation of various cycles of the filter system including the filtration cycle (also referred to as a service run) and a washing cycle. The washing cycle may be performed by directing the washing fluid in a path opposite to the path of influent during the filtration cycle or the washing cycle may be performed by directing the washing fluid in the same path as the path of the influent during the filtration cycle. The washing fluids may include influent, pre-filtered water, air or other suitable gas. A key function of the underdrain is to evenly distribute the washing fluid through the filter bed during the washing cycle so that at least a significant amount of the impurities trapped in the filter can be removed. In the event that the underdrain does not evenly distribute the washing fluid through the filter bed, the filter bed will likely not be properly cleaned. At a minimum, this will cause much shorter filtration cycles and more washing cycles. This is undesirable, as the filter system typically cannot operate in the filtration cycle during a washing cycle.

There are many different types of underdrain systems currently marketed for use in water filtration. Some underdrains are used for water only backwash and some are capable of introducing air only, water only, or simultaneous liquid and air.

A common type of underdrain is the “lateral” style. This type of underdrain is typically made of injection molded or extruded plastic or extruded clay. The underdrain blocks are arranged in rows termed “laterals”. The laterals are typically spaced on approximately 12 inch centers leaving an approximately 1 inch space between the laterals. Prior known underdrain laterals include combined air/water lateral type underdrains configured to introduce air and water simultaneously into the filter bed. However, mal-distribution is a concern with previously known combined air/water lateral type underdrains. As previously explained, mal-distribution can be problematic to the efficient operation of the filter system. Hence, a preferred form of the present invention is directed to an underdrain that eliminates or significantly reduces mal-distribution of washing fluids through a filter bed.

### OBJECTS AND SUMMARY OF THE INVENTION

An object of the present invention is to provide a novel and unobvious underdrain and a method of washing a filter system using the novel and unobvious underdrain.

Another object of a preferred embodiment of the present invention is to provide a lateral type underdrain that permits a combined liquid and air wash of a filter bed and eliminates or significantly reduces mal-distribution of the combined liquid and air wash.

A further object of a preferred embodiment of the present invention is to provide an insert that can be inserted into at least a portion of an underdrain lateral to improve the washing efficiency of the underdrain lateral.

Yet another object of a preferred embodiment of the present invention is to provide a baffle assembly for an underdrain lateral that improves the washing efficiency of the underdrain lateral.

Still another object of a preferred embodiment of the present invention is to provide an insert for an underdrain lateral that reduces or eliminates mal-distribution of the washing fluid released from the underdrain lateral where the insert is designed to be inserted in the underdrain lateral subsequent to formation of the underdrain lateral.

Yet a further object a preferred form of the present invention is to provide an underdrain lateral having three chambers running substantially the length of the underdrain lateral where each of the three chambers is configured to release a combined gas and liquid wash into the filter bed.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to a fluid distributor for use in a filter system for filtering water or wastewater. The fluid distributor includes a lateral having at least one chamber for receiving at least one fluid. The lateral is configured to receive and distribute at least one fluid through a filter bed of the filter system. The lateral has at least one opening. The fluid distributor further includes an insert configured to be inserted into the lateral through the opening of the lateral. The insert, when inserted into the lateral, forms at least one additional chamber in the lateral.

Another preferred embodiment of the present invention is directed to an apparatus for use in a filter system for filtering water or wastewater. The apparatus includes an underdrain lateral having at least a first chamber, a second chamber and a third chamber. A first baffle assembly having a plurality of baffles is disposed in the first chamber. The first baffle assembly forms a plurality of upper chambers in the first chamber and at least one lower chamber in the first chamber.

A further preferred embodiment of the present invention is directed to an apparatus for use in a filter system for filtering water or wastewater. The apparatus includes an underdrain lateral having at least a first chamber and a second chamber. The first chamber is in fluid communication with the second chamber. The apparatus further includes a baffle assembly having a plurality of baffles operably associated with at least one of the first chamber and the second chamber to vary at least one fluid distribution characteristic of the at least one of the first chamber and the second chamber.

Still a further preferred embodiment of the present is directed to an apparatus for use in a filter system for filtering water or wastewater. The apparatus includes an underdrain lateral. The underdrain lateral has at least a first chamber, a second chamber and a third chamber. A fluid flow control member having a substantially horizontally extending plate is disposed in the second chamber to form at least one upper chamber and at least one lower chamber. At least one of the first chamber and the third chamber is in fluid communication with the second chamber such that the at least one of the first chamber and the second chamber direct a washing gas and a washing liquid into the at least one upper chamber of the second chamber. The at least one lower chamber of the second chamber is configured to receive only a washing gas during a cleaning cycle.

### BRIEF DESCRIPTION OF THE DRAWINGS

FIG. 1 is a fragmentary plan view of an underdrain lateral formed in accordance with a preferred embodiment of the present invention with portions of the underdrain lateral removed.

FIG. 2 is a perspective view of the underdrain lateral illustrated in FIG. 1 with portions removed.

FIG. 3 is a cross-sectional view of the underdrain lateral illustrated in FIG. 1.

FIG. 4 is a perspective view of a baffle assembly formed in accordance with a preferred embodiment of the present invention with all but one baffle removed from the plate of the baffle assembly.

FIG. 5 is a plan view of the baffle assembly illustrated in FIG. 4.

FIG. 6 is front elevation view of a preferred form of a baffle of the baffle assembly.

FIG. 7 is a side view of the baffle assembly illustrated in FIG. 4.

FIG. 8 is front elevation view of the baffle assembly illustrated in FIG. 4.

FIG. 9 is a fragmentary plan view of an underdrain lateral formed in accordance with another preferred embodiment of the present invention with portions of the underdrain lateral removed.

FIG. 10 is a perspective view of the underdrain lateral illustrated in FIG. 9 with portions removed.

FIG. 11 is a cross-sectional view of the underdrain lateral illustrated in FIG. 9.

FIG. 12 is a cross-sectional view taken along lines B-B of FIG. 11.

### DETAILED DESCRIPTION OF THE PREFERRED EMBODIMENTS OF THE INVENTION

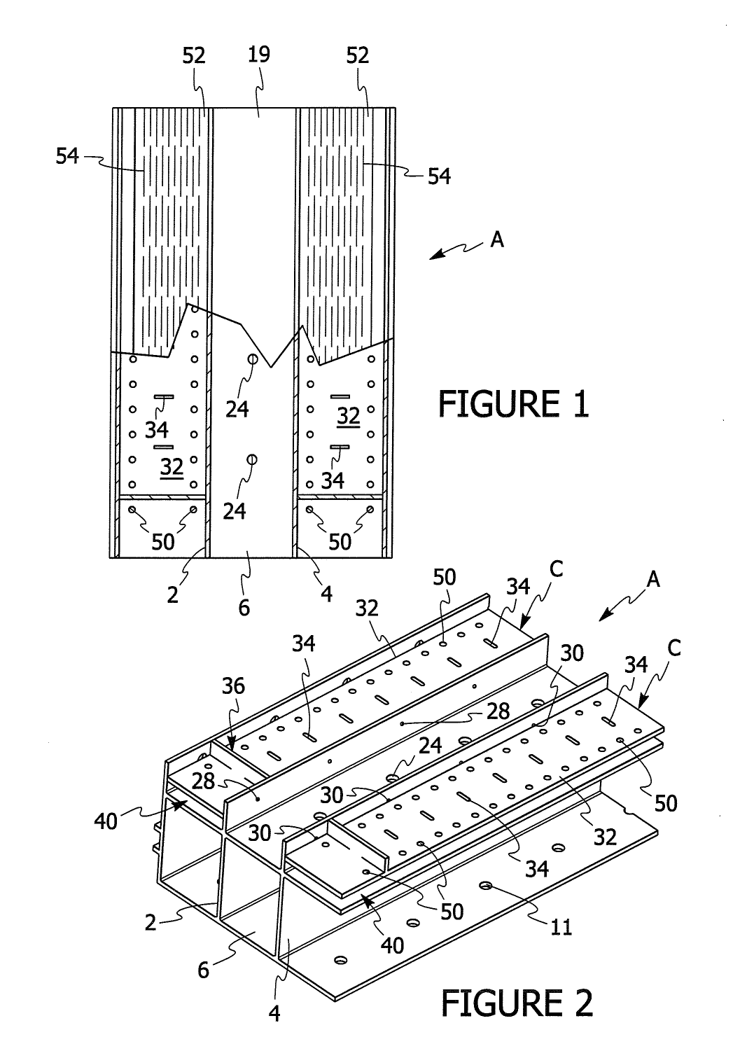

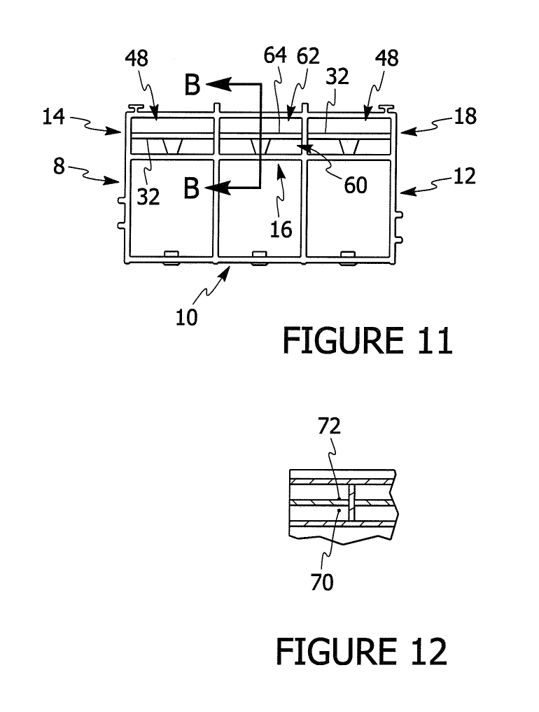

The preferred forms of the invention will now be described with reference to FIGS. 1-12. The appended claims are not limited to the preferred forms and no term and/or phrase used herein is to be given a meaning other than its ordinary meaning unless it is expressly stated that the term and/or phrase shall have a special meaning The term filter as used herein is broadly interpreted to include a device in which at least a portion of the impurities in a liquid are removed including but not limited to a clarifier, a polishing filter and/or a contactor.

### FIGS. 1-8

Referring to FIGS. 1 to 8, an underdrain lateral A formed in accordance with a preferred embodiment of the present invention is illustrated in one of many possible configurations. The number of underdrain laterals that are used in any given underdrain system will depend on the size of the filter. Preferably, underdrain lateral A is extruded in relatively long lengths to eliminate or reduce joints along the length of the lateral. However, the present invention is not limited in this fashion and a given lateral could comprise multiple underdrain blocks placed in an end-to-end relationship. The underdrain lateral A can be molded or extruded plastic, an extruded clay or any other suitable material.

Referring to FIGS. 1 to 3, underdrain lateral A is extruded as a single piece and includes internal vertical walls 2 and 4 and horizontal wall 6. Walls 2, 4 and 6, divide the interior of the underdrain lateral into three lower chambers 8, 10 and 12 and three upper chambers 14, 16 and 18. Outer, lower chambers 8 and 12 preferably are liquid wash only chambers as these chambers receive only a liquid during a wash cycle utilizing simultaneous liquid and gas. It should be noted that outer chambers 8 and 12 may have a small amount of air or other washing gas present. However, a washing gas is not initially introduced into these chambers from a washing fluid supply source. A washing liquid can be introduced from the supply source into chambers 8 and 12 at various different locations including the end of the lateral A via a flume disposed adjacent the ends of the underdrain laterals forming the underdrain system, through the top deck of the lateral A into chambers 8 and 12 via a sealed conduit or from the bottom of the underdrain lateral A via a flume positioned below and in fluid communication with openings 11 in the outer, lower chambers 8 and 12. The washing liquid can be influent, filtered water or any other suitable liquid.

Preferrably, gas only is introduced into the lower center chamber 10 during a wash cycle utilizing simultaneous liquid and air. The gas can be introduced in the same manner as the liquid is introduced into the outer, lower chambers 8 and 12. Air can be used as the washing gas. However, any suitable gas may be used. Evacuation openings may be formed in walls 2 and 4. The evacuation openings may be spaced along the length of the underdrain lateral to allow any residual water in center chamber 10 remaining from a filtration cycle to pass into chambers 8 and 12. The height of the evacuation openings may be varied along the length of the underdrain lateral A to compensate for velocity head or friction loss. Lower, center chamber 10 is in fluid communication with upper, center chamber 16 via a plurality of primary internal air distribution orifices 24 disposed above inner, lower chamber 10. Preferably, orifices 24 extend the length of underdrain lateral A. Openings 28 and 30 are formed in walls 2 and 4, respectively to allow the washing gas to pass from chamber 16 to chambers 14 and 18.

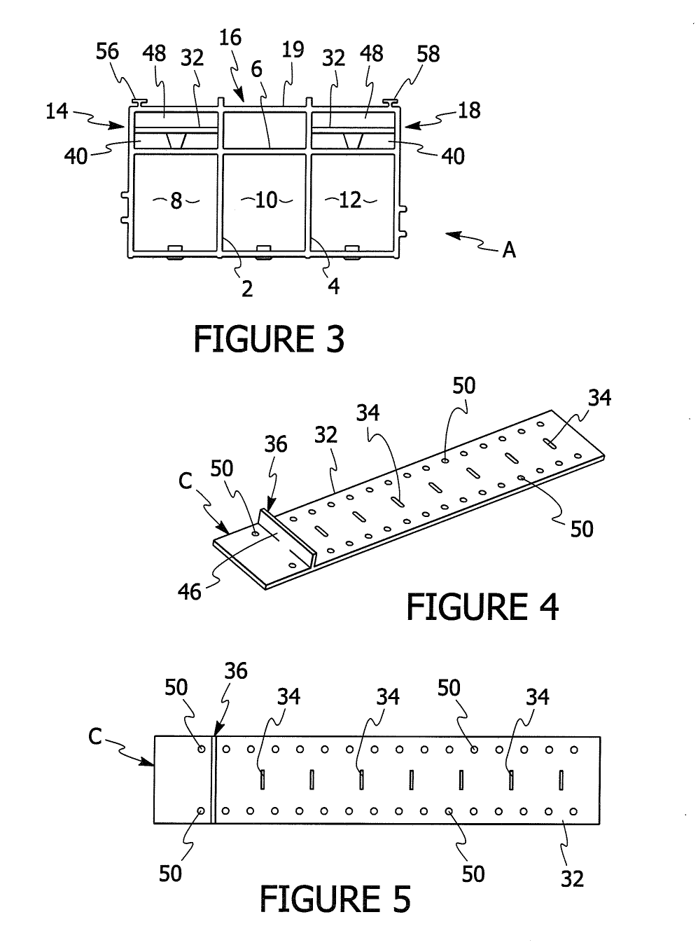

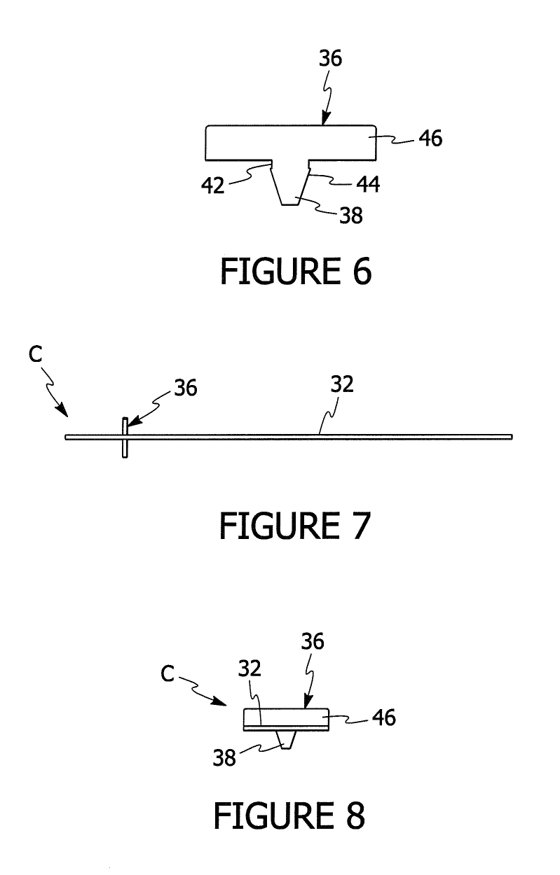

Referring to FIG. 2, openings 28 and 30 are positioned above plate 32 of baffle assembly C disposed in each of the outer, upper chambers 14 and 18. Each plate 32 has a plurality of transversely extending slots 34. Preferably, a baffle 36 is inserted into each of the slots 34. Referring to FIG. 6, baffles 36 include a leg portion 38 that extends below plate 32 and engages the bottom of the corresponding outer, upper chamber to support plate 32 above the bottom of the corresponding outer, upper chamber. Referring to FIG. 3, a lower chamber 40 is formed below plate 32 in each of outer, upper chambers 14 and 18. Plate 32 is held in place by neck portion 42 and shoulder portion 44 of baffle 36. Wall portions 46 of baffles 36 disposed in each of slots 34 create a plurality of upper chambers 48 in each of the upper, outer chambers 14 and 18. Plate 32 includes a plurality of openings 50 extending therethrough. Openings 50 are preferably positioned such that at least one opening is disposed in each of the plurality of upper chambers 48 formed in each of upper, outer chambers 14 and 18. While two openings are shown in each of the plurality of chambers 48, it will be readily appreciated that the number of openings may be varied as desired.

Lower, outer chambers 8 and 12 are in fluid communication with chambers 14 and 18, respectively via orifices (not shown) formed in internal wall 6 above outer, lower chambers 8 and 12. These orifices are preferably uniformly spaced along the length of the underdrain lateral A in a similar manner as orifices 24. The orifices in internal wall 6 above outer, lower chambers 8 and 12 allow the washing fluid in chamber 8 and 12 to pass into lower chamber 40 of the corresponding outer, upper chambers 14 and 18. Orifices 50 in plates 32 allow washing fluid in lower chambers 40 to pass into each of the plurality of upper chambers 48 of the outer upper chambers 14 and 18.

The location of openings 28 and 30 above the corresponding plates 32 introduces the washing gas from inner, upper chamber 16 into each of the upper chambers 48 of the outer upper chambers 14 and 18 where the washing gas is mixed with the washing liquid thereby bypassing lower chambers 40. Notably, chambers 40 during a cleaning cycle receive substantially only a washing liquid.

In the preferred form of underdrain lateral A, top surface 52 includes a plurality of slots 54 formed therein above the upper outer chambers 14 and 18. It will be readily appreciated that slots may also be formed in top surface 19 above upper chamber 16. The slots 54 allow the underdrain lateral A to release from the upper chambers 14, 16 and 18 a washing liquid and a washing gas into the filter bed supported by underdrain laterals A. Slots 54 are preferably formed using a laser to cut the slots into top surface 52. The width of the slots is relatively narrow to prevent media supported directly by the underdrain lateral from passing through and/or clogging slots 54 obviating the need for a porous plate or other separate media support member. In the most preferred form, each slot 54 has a length of 1.5 inches and a width of 0.0115 inches. However, the length and width of the slots can be readily varied as desired. For example, where the underdrain lateral A is used in connection with filtration of wastewater, the width of the slots 54 can be considerably larger due to the larger size media used in filtration of wastewater. Larger size slots can be formed using techniques other than laser cutting. Further, the shape of the slots can be readily varied and can include circular openings.

However, in the event that a porous plate is used, underdrain lateral A may include rails 56 and 58, as seen in FIG. 3, that allow a porous plate to be detachably connected to the underdrain lateral A in the manner described in detail in U.S. Pat. No. 6,325,931, the entire contents of which is herein incorporated by reference. It will be readily appreciated that a porous plate, if used, can be attached to the underdrain lateral A in any suitable manner. It should be noted that the rails 56 and 58 can be omitted. Further, underdrain lateral A may be used without a porous plate or other separate media support member due to the sizing of slots 54.

Preferably, baffle assembly C is configured so that baffle assembly can be inserted after the underdrain lateral has been formed. Hence, the baffle assembly C could be used to retrofit existing underdrain laterals. The baffle assembly C may be formed from the same material as the underdrain lateral or any other suitable material. Preferably, the baffle assembly is formed from PVC.

During a filtration cycle, all portions of all of the six chambers 8, 10, 12, 14, 16 and 18 are filled with liquid. Where the filter is a downflow filter, filtered water flows downwardly through underdrain lateral A into a flume or other channel means to remove the effluent from the filter. During a gas only wash cycle, gas such as air is introduced into chamber 10. Air will be metered into chamber 16 via orifices 24. Air will pass into upper chambers 48 of outer, upper chambers 14 and 18 through orifices 28 and 30, respectively and escape into the filter through slots 54. If slots are disposed above chamber 16, air will also be released into the filter bed directly from chamber 16.

During a simultaneous liquid and gas wash cycle, air is introduced in underdrain lateral A and the filter bed in the same manner as described above. Simultaneously, a washing liquid is introduced into the lower, outer chambers 8 and 12. The washing liquid travels from lower, outer chambers 8 and 12 into the lower chamber 40 of the corresponding outer, upper chambers 14 and 18. The washing liquid passes from lower chamber 40 of the outer, upper chamber 14 and 18 into each of the upper chambers 48 of the outer, upper chamber 14 and 18 where it mixes with the washing gas. Combined liquid and gas flow into the filter bed through slots 54 formed above outer, upper chambers 14 and 18. If slots 54 are formed above inner, upper chamber 16, gas only will flow into the bed through slots 54 formed above inner, upper chamber 16 at the same time liquid and air is released into the bed from chambers 14 and 18.

During liquid only wash cycle, liquid is introduced into chambers 8 and 12 and distributed as described above. Notably, just liquid will flow through slots 54.

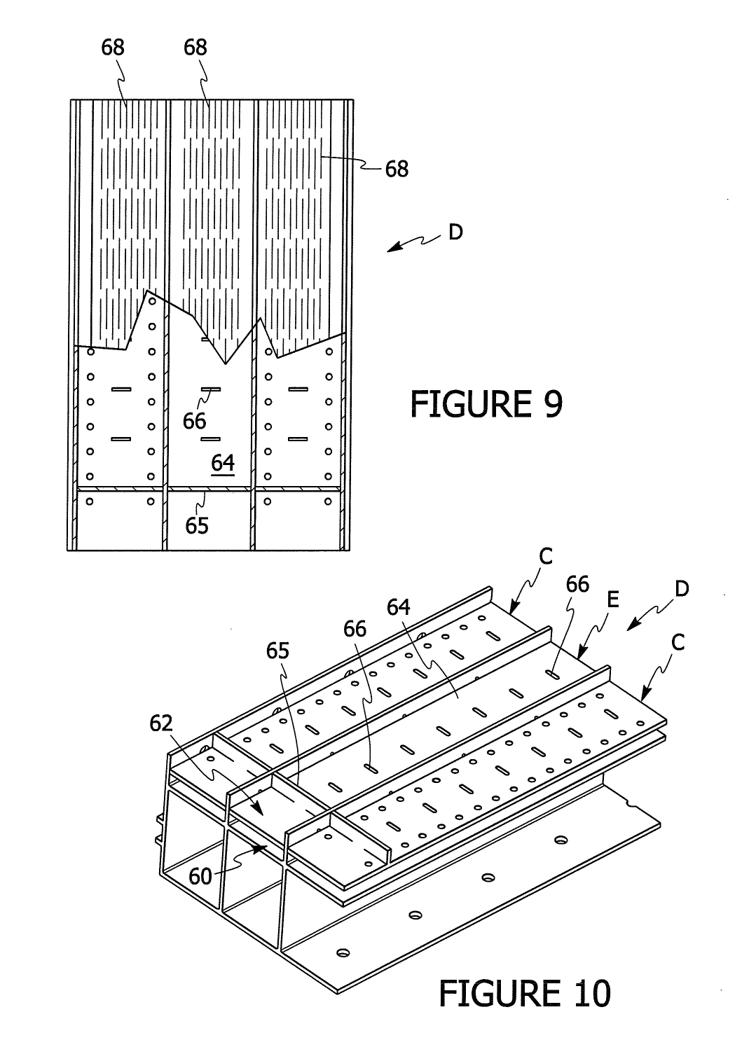

### FIGS. 9-12

Underdrain lateral D depicted in FIGS. 9 through 12 is similar to underdrain lateral A and, therefore, only the differences will be described in detail. A baffle assembly E is disposed in inner, upper chamber 16. The baffle assembly E creates a lower chamber 60 and a plurality of upper chambers 62. The only difference between baffle assembly E and baffle assembly C is that plate 64 lacks openings 50. Baffle assembly E, like baffle assembly C, has a baffle 65 identical to baffle 36 positioned in each of slots 66. Slots 68 are formed above each of the upper chambers 14, 16 and 18.

Referring to FIGS. 10 and 12, openings 70 are formed in each of internal walls 2 and 4 below plates 32 of baffle assemblies C disposed in outer, upper chambers 14 and 18 and plate 62 of baffle assembly E disposed in inner, upper chamber 16. Openings 72 are formed in each of internal walls and 4 above plates 32 of baffle assemblies C disposed in outer, upper chambers 14 and 18 and plate 62 of baffle assembly E disposed in inner, upper chamber 16. This configuration directs a washing gas from lower chamber 60 into each of the lower chambers 40 of outer, upper chambers 14 and 18 through openings 70. When the washing cycle includes simultaneous liquid and gas, the washing gas passing from lower chamber 60 into each of the lower chambers 40 of outer, upper chambers 14 and 18 will mix with the washing liquid. The mixture of washing gas and washing liquid will pass from each of the lower chambers 40 into each of the plurality of the upper chambers 48 of the outer, upper chambers 14 and 18. A portion of the mixture of washing liquid and washing gas in each of upper chambers 48 will pass into upper chambers 62 of the inner, upper chamber 16 through openings 72. A mixture of liquid and gas will be released from each of the upper chambers 14, 16 and 18 through slots 68. It may be desirable to have fewer slots 68 above inner, upper chamber 16 than are above outer, upper chambers 14 and 18.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

I claim:

1. A fluid distributor for use in a filter system for filtering water or wastewater, said fluid distributor comprising:
(a) a lateral having at least one chamber for receiving at least one fluid, said lateral being configured to receive and distribute at least one fluid through a filter bed of the filter system, said lateral having at least one opening; and,
(b) an insert configured to be inserted into said lateral through said opening of said lateral, said insert, when inserted into said lateral, forming at least one additional chamber in said lateral.

2. A fluid distributor as set forth in claim 1, wherein:
(a) said insert, when inserted into said lateral, forms at least two additional chambers in said lateral.

3. A fluid distributor as set forth in claim 2, wherein:
(a) said insert includes a plurality of baffles.

4. A fluid distributor as set forth in claim 3, wherein:
(a) said insert further includes a plate having a plurality of slots, each of said plurality of baffles extend into one of said plurality of slots such that a lower portion of each of said plurality of baffles extends below said plate and an upper portion of each of said plurality of baffles extends above said plate.

5. A fluid distributor as set forth in claim 4, wherein:
(a) said upper portions of said plurality of baffles form a plurality of chambers above said plate.

6. A fluid distributor as set forth in claim 5, wherein:
(a) said upper portion of each of said plurality of baffles has a width substantially equal to a width of said plate; and,
(b) said lower portion of each of said plurality of baffles has a width substantially less than the width of said plate.

7. A fluid distributor as set forth in claim 6, wherein:
(a) said plate has a plurality of openings configured to allow a fluid to flow therethrough.

8. An apparatus for use in a filter system for filtering water or wastewater, said apparatus comprising:
(a) an underdrain lateral, said underdrain lateral having at least a first chamber and a second chamber;
(b) said first chamber being in fluid communication with said second chamber; and,
(c) a baffle assembly having a plurality of baffles operably associated with at least one of said first chamber and said second chamber to vary at least one fluid distribution characteristic of said at least one of said first chamber and said second chamber.

9. An apparatus as set forth in claim 8, wherein
(a) said baffle assembly includes a plate, a first portion of each of said plurality of baffles extends above said plate and a second portion of each of said plurality of baffles extend below said plate.

10. An apparatus as set forth in claim 9, wherein:
(a) said baffle assembly is positioned in said first chamber, said second portion of each of said plurality of baffles engages a bottom surface of said first chamber such that a bottom surface of said plate is disposed above the bottom surface of the first chamber to form a lower chamber between said bottom surface of said first chamber and said bottom surface of said plate; and,
(b) said plurality of baffles form a plurality of upper chambers in said first chamber above said plate.

11. An apparatus as set forth in claim 10, wherein:
(a) said first chamber and said second chamber have a common wall, said common wall having a plurality of openings allowing fluid to flow between said first chamber and said second chamber.

12. An apparatus as set forth in claim 11, wherein:
(a) said plurality of openings in said common wall are disposed above an uppermost surface of said plate.

13. An apparatus as set forth in claim 12, wherein:
(a) said second chamber is configured to direct only a washing gas to said first chamber above said plate.

14. An apparatus as set forth in claim 13, wherein:
(a) said lateral further includes a third chamber in fluid communication with said first chamber for directing a washing liquid into said lower chamber of said first chamber below said plate of said baffle assembly.

15. An apparatus as set forth in claim 13, wherein:
(a) said plate has a plurality of openings to allow a washing liquid to flow from said lower chamber of said first chamber into each of said plurality of upper chambers of said first chamber.

16. An apparatus for use in a filter system for filtering water or wastewater, said apparatus comprising:
(a) an underdrain lateral, said underdrain lateral having at least a first chamber, a second chamber and a third chamber;
(b) a first baffle assembly having a plurality of baffles being disposed in said first chamber, said first baffle assembly forming a plurality of upper chambers in said first chamber and at least one lower chamber in said first chamber.

17. An apparatus as set forth in claim 16, further including:
(a) a second baffle assembly having a plurality of baffles being disposed in said third chamber, said second baffle assembly forming a plurality of upper chambers in said third chamber and at least one lower chamber in said third chamber.

18. An apparatus as set forth in claim 17, wherein:
(a) said second chamber is disposed between said first chamber and said third chamber and directs a washing gas into each of said upper chambers of said first chamber and said third chamber.

19. An apparatus as set forth in claim 18, wherein:
(a) said lower chamber of said first chamber is in fluid communication with each of said plurality of upper chambers of said first chamber so that a washing liquid received in said lower chamber of said first chamber passes into each of said upper chambers of said first chamber when a filter bed is undergoing a washing procedure.

20. An apparatus as set forth in claim 19, wherein:
(a) said lower chamber of said third chamber is in fluid communication with each of said plurality of upper chambers of said third chamber so that a washing liquid received in said lower chamber of said third chamber passes into each of said upper chambers of said third chamber when a filter bed is undergoing a washing procedure.

21. An apparatus for use in a filter system for filtering water or wastewater, said apparatus comprising:
(a) an underdrain lateral, said underdrain lateral having at least a first chamber, a second chamber and a third chamber;
(b) a fluid flow control member being disposed in said second chamber, said fluid flow control member having a substantially horizontally extending plate forming at least one upper chamber and at least one lower chamber in said second chamber; and,
(c) at least one of said first chamber and said third chamber being in fluid communication with said second chamber such that the at least one of said first chamber and said second chamber directs a washing gas and a washing liquid into said upper chamber of said second chamber, said at least one lower chamber of the second chamber being configured to receive only a washing gas during a cleaning cycle.
